(19) United States
(12) Patent Application Publication
(10) Pub. No.: US 2026/0356741 A1
(43) Pub. Date: Nov. 12, 2026

(54) COATED GLASS BUBBLES AND METHODS OF MAKING COATED GLASS BUBBLES BY MECHANICAL EXFOLIATION

(71) Applicant: 3M INNOVATIVE PROPERTIES COMPANY, St. Paul, MN (US)

(72) Inventors: Dipankar Ghosh, Oakdale, MN (US); Gezahegn D. Damte, Cottage Grove, MN (US)

(21) Appl. No.: 19/138,378

(22) PCT Filed: Nov. 10, 2023
(86) PCT No.: PCT/IB2023/061387

§ 371 Date: Jun. 12, 2025

Related U.S. Application Data
(60) Provisional application No. 63/476,394, filed on Dec. 21, 2022.

(51) Int. Cl. C03C 17/22; C03C 3/089; C03C 11/00; C03C 12/00; C03C 17/23; C08K 3/04; C08K 3/38; C08K 7/28

(52) U.S. Cl. CPC C03C 17/225; C03C 3/089; C03C 11/002; C03C 12/00; C03C 17/23; C08K 3/042; C08K 3/38; C08K 7/28; C03C 2217/281; C03C 2217/42; C03C 2218/10

(57) ABSTRACT

Coated glass bubbles comprising glass bubbles, each having an outer surface, and a coating comprising flakes in direct contact with the outer surface. The flakes comprise less than 5 wt. % of the coated glass bubbles. The coated glass bubbles may be dispersed within a polymer matrix to form composites. The composites may be used to create articles for a variety of applications, including 5G applications.

### BACKGROUND

Glass bubbles, also referred to as hollow glass microspheres, are used in a variety of applications ranging from explosive materials to advances in the electrification of automobiles. Glass bubbles are often used as fillers to lower the density, the coefficient of thermal expansion, and/or the thermal conductivity of other materials. Glass bubbles can also be added to materials to lower the dielectric permittivity and dielectric loss, making them suitable for producing lightweight composites with desired electrical properties (e.g., printed circuit boards and radomes).

### SUMMARY

Glass bubbles are currently being explored as fillers for composites used in 5G applications. Glass bubbles can lower dielectric values of the composite, thus providing better electromagnetic signal transmission and better signal-to noise-ratios. However, glass bubbles, such as those composed of soda-lime borosilicate glass, have a tendency to absorb water, which can actually increase the dielectric permittivity and/or loss of a composite and, in some instances, also lead to undesirable heating resulting from the energy loss. With the telecommunications industry shifting to ever higher frequencies, there is an increasing demand for materials that exhibit a low dielectric constant and a low dielectric loss.

The present disclosure provides coated glass bubbles that may reduce water adsorption and/or reduce dielectric loss of glass bubbles, thus making then ideally suited for applications in the telecommunications and electronics industry.

In one embodiment, the present disclosure provides coated glass bubbles comprising: glass bubbles, each glass bubble having an outer surface; and a coating comprising flakes in direct contact with the outer surface, wherein the flakes comprise less than 5 weight percent (wt. %) of the coated glass bubbles.

In another embodiment, the present disclosure provides a composite comprising a polymer and the coated glass bubbles dispersed with the polymer.

In yet another embodiment, the present disclosure provides an article comprising the composite.

In a further embodiment, the present disclosure provides a method of making the coated glass bubbles comprising: combining the glass bubbles with a layered precursor; mechanically exfoliating the layered precursor to create flakes; and coating the glass bubbles with the flakes.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The terms “a,” “an,” and “the” are used interchangeably with “at least one” to mean one or more of the components being described.

The term “and/or” means one or all of the listed elements or a combination of any two or more of the listed elements.

The term “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The terms “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

All numbers are assumed to be modified by the term “about”. As used herein in connection with a measured quantity, the term “about” refers to that variation in the measured quantity as would be expected by the skilled artisan making the measurement and exercising a level of care commensurate with the objective of the measurement and the precision of the measuring equipment used.

The recitations of numerical ranges by endpoints include all numbers subsumed within that range as well as the endpoints (e.g., 1 to 5 includes 1, 1.5, 2, 2.75, 3, 3.80, 4, 5, etc.). The phrase “up to” a number (e.g., up to 50) includes the number (e.g., 50).

The term “aspect ratio” means the ratio of the longest dimension of a material to the shortest dimension in a direction perpendicular to the longest dimension.

The term “layered precursor” means a material comprising layers held together by weak chemical forces that can be overcome by mechanical exfoliation. In some embodiments, the layers are held together by Van der Waals forces.

The term “flake” means a material separated from a layered precursor. Flakes can be derived from layered precursors that have been subject to mechanical exfoliation, resulting in flakes having less layers than the layered precursors from which they are derived. In some embodiments, flakes have no more than 10 layers.

The term “mechanical exfoliation” means the application of shear force by mechanical means (e.g., mechanical stirring) to break up a layered precursor into flakes.

The above summary of the present disclosure is not intended to describe each disclosed embodiment or every implementation of the present disclosure. The description that follows more particularly exemplifies illustrative embodiments.

### BRIEF DESCRIPTION OF DRAWINGS

FIG. 1 is an exemplary coated glass bubble of the present disclosure.

Unless otherwise indicated, all figures and drawings in this document are not to scale and are chosen for the purpose of illustrating different embodiments of the invention. In particular, the dimensions of the various components are depicted in illustrative terms only, and no relationship between the dimensions of the various components should be inferred from the drawings, unless so indicated.

### DETAILED DESCRIPTION

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

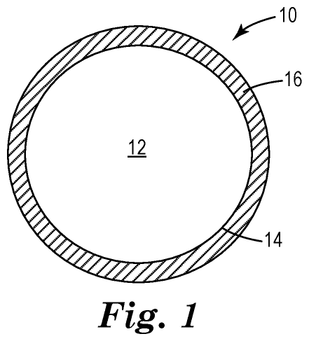

As illustrated in FIG. 1, the coated glass bubbles 10 of the present disclosure generally comprise glass bubbles 12, each glass bubble 12 having an outer surface 14 and a coating 16 comprising flakes in direct contact with the outer surface 14. The term “direct contact”, as used herein, means that the coating is in physical contact with the surface of the glass bubble (i.e., no intermediate coating or layer). The flakes comprise less than 5 wt. % of the coated glass bubbles. Each of the components is described in further detail below.

### Glass Bubbles

The glass bubbles, as used herein, refer to hollow spheres made of glass, each having a substantially single-cell structure (i.e., each bubble is defined by only the outer wall with no additional exterior walls, partial spheres, concentric spheres, or the like present in each individual bubble). The hollow spheres have a rounded shape, e.g., an egg-shape, a pearl shape, a bead shape, an ellipsoidal shape, a spheroidal shape, or a spherical shape. Preferably, the hollow spheres have a spherical shape. The glass bubbles may have an aspect ratio ranging from 1 to 50, 1 to 40, 1 to 30, 1 to 20, 1 to 10, or 1 to 5. In some embodiments, the aspect ratio is 1.

The size of the glass bubbles are not particularly limiting and will depend upon the application for which they are intended. The term “size”, as used in this context, refers to the largest diameter of a glass bubble. In some embodiments, the glass bubbles can have a median size by volume in a range from 1 to 500 micrometers, 1 to 100 micrometers, 5 to 100 micrometers, or from 10 to 60 micrometers (in some embodiments from 15 to 40 micrometers, 10 to 25 micrometers, 20 to 45 micrometers, 20 to 40 micrometers, 10 to 50 micrometers, or 10 to 30 micrometers). The median size is also called the d₅₀ size, where 50 percent by volume of the glass bubbles in the distribution are smaller than the indicated size, and 50 percent by volume of the glass bubbles in the distribution are greater than the indicated size.

Glass bubbles according to and/or useful for practicing the present disclosure can be made by techniques known in the art (see, e.g., U.S. Pat. No. 2,978,340 (Veatch et al.); U.S. Pat. No. 3,030,215 (Veatch et al.); U.S. Pat. No. 3,129,086 (Veatch et al.); U.S. Pat. No. 3,230,064 (Veatch et al.); U.S. Pat. No. 3,365,315 (Beck et al.); U.S. Pat. No. 4,391,646 (Howell); and U.S. Pat. No. 4,767,726 (Marshall); and U. S. Pat. App. Pub. No. 2006/0122049 (Marshall et. al)). Techniques for preparing glass bubbles typically include heating milled frit, commonly referred to as “feed”, which contains a blowing agent (e.g., sulfur or a compound of oxygen and sulfur). The resultant product (that is, “raw product”) obtained from the heating step typically contains a mixture of glass bubbles, broken glass bubbles, and solid glass beads, the solid glass beads generally resulting from milled frit particles that failed to form glass bubbles for whatever reason. The milled frit typically has range of particle sizes that influences the size distribution of the raw product. During heating, the larger particles tend to form glass bubbles that are more fragile than the mean, while the smaller particles tend to increase the density of the glass bubble distribution. When preparing glass bubbles by milling frit and heating the resulting particles, the amount of sulfur in the glass particles (i.e., feed) and the amount and length of heating to which the particles are exposed (e.g., the rate at which particles are fed through a flame) can typically be adjusted to vary the density of the glass bubbles. Lower amounts of sulfur in the feed and faster heating rates lead to higher density bubbles as described in U.S. Pat. No. 4,391,646 (Howell) and U.S. Pat. No. 4,767,726 (Marshall). Furthermore, milling the frit to smaller sizes can lead to smaller, higher density glass bubbles.

Although the frit and/or the feed may have any composition that is capable of forming a glass, in some embodiments the frit comprises from 50 to 90 wt. % SiO₂, from 2 to 20 wt. % alkali metal oxides (for example, Na₂O or K₂O), from 1 to 30 wt. % B₂O₃, from 0.005-0.5 wt. % sulfur (for example, as elemental sulfur, sulfate or sulfite), from 0 to 25 wt. % divalent metal oxides (for example, CaO, MgO, BaO, SrO, ZnO, or PbO), from 0 to 10 wt. % tetravalent metal oxides other than SiO₂ (for example, TiO₂, MnO₂, or ZrO₂), from 0 to 20 wt. % trivalent metal oxides (for example, Al₂O₃, Fe₂O₃, or Sb₂O₃), from 0 to 10 wt. % oxides of pentavalent atoms (for example, P₂O₅ or V₂O₅), and from 0 to 5 wt. % fluorine (as fluoride) which may act as a fluxing agent to facilitate melting of the glass composition. Additional ingredients are useful in frit compositions and can be included in the frit, for example, to contribute particular properties or characteristics (for example, hardness or color) to the resultant glass bubbles.

In some embodiments, the glass bubbles comprise a soda-lime borosilicate glass.

In some embodiments, the glass bubbles comprise 50 to 90 wt. % silica (SiO₂), 2 to 20 wt. % alkali metal oxides (R₂O), and 1 to 30 wt. % boron oxide (B₂O₃), based on the total weight of the glass bubble. In the same, or different embodiments, the glass bubble comprises no greater than 25 wt. % divalent metal oxide (RO), more particularly calcium oxide (CaO). In the same, or different embodiments, the glass bubble further comprises no greater than 10 wt. % phosphorus oxide (P₂O₅). As used herein, “R” refers to a metal having the valence indicated, R₂O an alkali metal oxide and RO being a divalent metal oxide, preferably an alkaline earth metal oxide.

Suitable glass bubbles may also be obtained commercially from, for example, 3M Company (Saint Paul, Minnesota) under the designation 3M™ Glass Bubbles K, S, iM, XLD, Floated and HGS Series, including Glass Bubbles iM16K, Glass Bubbles S60, Glass Bubbles K42HS and Glass Bubbles S32HS. In some embodiments, the glass bubbles are Glass Bubbles iM16K, Glass Bubbles S32HS, and combinations thereof. In some embodiments, the glass bubbles are iM16K.

The glass bubbles of the present disclosure typically have an average true density of at least 0.2 grams per cubic centimeter (g/cm³), 0.25 g/cm³, or 0.3 g/cm³. In some embodiments, the glass bubbles have an average true density of up to 0.65 g/cm³, 0.6 g/cm³, or 0.55 g/cm³. For example, the average true density of the glass bubbles may be in a range from 0.2 g/cm³ to 0.65 g/cm³, 0.25 g/cm³ to 0.6 g/cm³, 0.3 g/cm³ to 0.60 g/cm³, or 0.3 g/cm³ to 0.55 g/cm³. The “average true density” or “real density” of the glass bubbles is the quotient obtained by dividing the mass of a sample of glass bubbles by the true volume of that mass of glass bubbles. The “true volume” is the aggregate total volume of the glass bubbles, not the bulk volume. The average true density can be measured using a pycnometer according to DIN EN ISO 1183-3. The pycnometer may be obtained, for example, under the trade designation “ACCUPYC II 1340 PYCNOMETER” from Micromeritics, Norcross, Georgia, or under the trade designations “PENTAPYCNOMETER” or “ULTRAPYCNOMETER 1000” from Formanex, Inc., San Diego, CA. Average true density can typically be measured with an accuracy of 0.001 g/cm³. Accordingly, each of the density values provided above can be ±five percent.

### Coating

The coating comprises flakes in direct contact with the outer surfaces of the glass bubbles. Flakes may be derived from layered precursors that comprises individual layers held together by weak chemical forces (e.g., Van der Waals forces). In contrast, the atoms and/or ions within the layers are held together by stronger chemical forces. Mechanical exfoliation can be use to sheer off layers from the layered precursors to form flakes. These flakes are thinner than the layered precursors from which they are derived and, due to their smaller size, exhibit unique physical and chemical properties that are distinct from the bulk layered precursors. In some embodiments, the flakes have no more than 10, 9, 8, 7, 6, 5, 4, 3, 2 or 1 layers. In some embodiments, the flakes have 1 to 10 layers, 1 to 5 layers, or even 1 layer.

The flakes typically have a mean aspect ratio of at least 2:1, 15:1, 30:1, or 50:1. In some embodiments, the mean aspect ratio of the flakes range from 2:1 to 50:1 or 2:1 to 30:1. The mean aspect ratio can be determined by averaging the aspect ratio of 20 flakes obtained using scanning electron microscopy (SEM). The aspect ratio of a single flake is determined by measuring the length (longest dimension) and the thickness of the flake and calculating the ratio of the length to the thickness. Required magnification of the SEM images used to measure length and thickness of the flakes depends on the size of the platelets.

In some embodiments, the mean length of the flakes is at least 10, 15, 20, 25, 30, 35, 40, 45, or 50 micrometers. In some embodiments, the mean length of the flakes ranges from 10 to 50, from 10 to 40, from 10 to 30, or from 10 to 20 micrometers. The mean length can be determined by averaging the length of 20 flakes using SEM, as described above.

The materials that make up the layered precursor, and flakes derived therefrom, are generally hydrophobic, electrically resistant, or combinations thereof. In preferred embodiments, such as 5G applications, the materials are both hydrophobic and electrically resistant.

Hydrophobic materials, as used herein, refer to a materials that tends to repel water and have a contact angle of at least 90°, where the contact angle refers to the angle between the surface of the material and the tangent of a water droplet on the surface of the material. Hydrophobic coating materials minimize the adsorption of water by the glass bubbles, particularly those made of soda-lime borosilicate glass, which can increase the dielectric permittivity and/or loss of a composite and, in some instances, also lead to undesirable heating resulting from the energy loss.

Electrically resistant materials, as used herein, refer to a materials having an electrical resistance of at least 10⁹ Ω·cm. Electrically resistant materials typically have lower dielectric constants and lower dielectric loss, which make them particularly suitable for electronic applications.

Exemplary layered precursors that are both hydrophobic and electrically resistant include hexagonal boron nitride (h-BN), graphene oxide (GO), graphitic carbon nitride, or combinations thereof. For purposes of clarity, graphene oxide (GO) does not include reduced graphene oxide (rGO) which exhibits electrical conductivity. Flakes suitable for use in the present application may be obtained by mechanical exfoliation of the layered precursors.

In some embodiments, the flakes comprise hexagonal boron nitride (h-BN), graphene oxide (GO), graphitic carbon nitride, or combinations thereof. In some embodiments, the flakes comprise h-BN, GO, or combinations thereof. In some preferred embodiments, the flakes comprise h-BN. In addition to hydrophobicity and high electrical resistivity, h-BN exhibits high thermal conductivity, high temperature resistance, and low density, making it particularly suitable for electronic packaging applications.

The flakes directly adhere to the surface of the glass bubbles forming a coating thereon. By “adhere to the surface” it is meant that the flakes are fixed on the surface of the individual glass bubbles. When the coated glass bubbles as disclosed herein are used as filler for polymers and compounded with a polymer matrix material, the flakes remain adhered to the surface of the glass bubbles.

The flakes of the coating may be placed in layers one upon another, or may be placed in an irregular manner on the surface of the glass bubbles. Individual flakes may be oriented parallel to the surface of the glass bubbles, or may be oriented in any direction not parallel to the surface of the glass bubbles. Individual flakes may also be oriented perpendicularly to the surface of the glass bubbles, i.e., in a radial manner. In some embodiments, most of the flakes, i.e., more than 50% of the flakes, are oriented parallel to the surface of the glass bubbles.

The coating may be continuous or discontinuous on the outer surface of the glass bubbles. In some embodiments, the coating covers at least 50, 60, 70, 80, 90 or 100% of the outer surface of the glass bubble. In some embodiments, the coating covers at least 90, 95 or 100% of the outer surface of the glass bubbles. In preferred embodiments, the coating covers 100% of the outer surface of the glass bubble.

The coating of the coated glass bubbles, as disclosed herein, typically does not comprise a binder. As used herein, “binder” means an organic or inorganic compound that has the function of adhering the flakes to one another and/or to the surface of the glass bubbles, and that has been added to the glass bubbles and the flakes in the process for making the coated glass bubbles.

The thickness of the coating is preferably as thin as practically possible. To some extent this will depend upon the application. Coatings that are too thin may be more susceptible to influences of moisture. Coatings that are too thick will provide little additional moisture resistance but lead to higher dielectric constants (e.g., higher dielectric loss). Typically, the coating thickness is less than the smallest dimension of the glass bubbles to which it is applied. In some embodiments, the thickness of the coating ranges from 2 nanometers to 5 micrometers, or 5 nanometers to 3 micrometers. The thickness of the coating of the coated glass bubbles may be measured by crushing or fracturing of the plurality of coated glass bubbles by uniaxially pressing with a load of 10 kN and measurement of the thickness of the coating on the obtained fractured pieces of the coated glass bubbles by scanning electron microscopy (SEM).

The flakes comprise less than 5, 4.5, 4, 3.5, 3, 2.5, or 2 wt. % of the coated glass bubbles. In some embodiments, the flakes comprise 0.5 to 5 wt. %, 0.5 to 4.5 wt. %, 0.5 to 3.5 wt. %, 0.5 to 3 wt. % of the coated glass bubbles.

The coated glass bubbles of the present disclosure typically have a lower moisture sensitivity than the uncoated glass bubbles (e.g., glass bubbles prior to coating), as determined by the Sensitivity Test set forth in the Examples section. In some embodiments, the coated glass bubbles have a moisture sensitivity of no more than 3000 parts per million (ppm), 2900 ppm, 2850 ppm, 2800 ppm, 2750 ppm, 2700 ppm, 2650 ppm, 2600 ppm, 2550 ppm, or 2500 ppm. In some embodiments, the moisture sensitivity of the coated glass bubbles is at least 5%, 10%, 15% or even 20% lower than the moisture sensitivity of the uncoated glass bubbles.

The coated glass bubbles of the present disclosure typically exhibit a dielectric permittivity (ε′) and a dielectric loss (tan δ) less than the uncoated glass bubbles.

### Coating Method

The coated glass bubbles of the present disclosure can be made by combining the glass bubbles with a layered precursor, mechanically exfoliating the layered precursor to create flakes, and coating the glass bubble with the flakes. The weight ratio of glass bubbles to layered precursor is at least 20:1, 25:1, 30:1, 35:1 or at least 40:1. Typically, the weight ratio of glass bubbles to layered precursor is up to 50:1, 45:1, or 40:1. In some embodiments, the weight ratio of glass bubbles to layered precursor ranges from 20:1 to 50:1, 20:1 to 40:1, or 20:1 to 30:1. If the amount of layered precursor is too high, sufficient exfoliation of the layers may not occur.

Mechanical exfoliation separates the layers within the layered precursor to create flakes. Exfoliation is typically carried out in a ball milling roller using relatively low mixing speeds and long mixing times. In some embodiments, the exfoliation is carried out at mixing speeds of at least 20, 25, 30, 40 revolutions per minute (rpm). In the same or alternative embodiments, the exfoliation is carried out at mixing speeds up to 60, 55, 50, 45, 40 rpm. In some embodiments, the exfoliation is carried out at mixing speeds ranging from 20 to 60, or 20 to 40 rpm. In some embodiments, the mixing time is at least 12, 18, or 24 hours. In the same or alternative embodiments, the mixing time is up to 54, 48, 42, or 36 hours. In some embodiments, the mixing time ranges from 12 to 54, from 12 to 48, from 12 to 42, from 12 to 36 hours.

The flakes obtained through exfoliation are simultaneously buff coated onto the outer surface of the glass bubbles in the ball milling roller. Simultaneously, as used in the context, means that exfoliation and buff coating are occurring within the mixing time mentioned above. Buff coating refers to an operation in which a pressure is applied normal to a subject surface (e.g., the outer surface of the glass bubble) coupled with movement of flakes (e.g., rotational, lateral, combinations thereof) in a plane parallel to said surface.

The coating method can be carried out at room temperature (i.e., the method does not require heat treatment). This provides a low cost alternative to those coating processes using heat treatment and eliminates the need to soften the surface of the glass bubble.

In some embodiments, the coating method is substantially free of added liquids (e.g., solvents). The word “substantially” in this instance means that no liquids are added to the mixture of glass bubbles and layered precursor during the coating process.

### Composite

The glass bubbles of the present disclosure may be used in a wide variety of applications, for example, in filler applications, modifier applications or containment applications. The coated glass bubbles may be used as filler in composite materials, where they impart properties of cost reduction, weight reduction, and/or performance enhancement. More specifically, they may be used as fillers in polymers (including thermoset, thermoplastic, and inorganic geopolymers), inorganic cementitious materials (including material comprising Portland cement, lime cement, alumina-based cements, plaster, phosphate-based cements, magnesia-based cements and other hydraulically settable binders), concrete systems (e.g., precise concrete structures, tilt up concrete panels, columns, or suspended concrete structures), putties (e.g., for void filling and/or patching applications), wood composites (e.g., particleboards, fiberboards, wood/polymer composites, and other composite wood structures), clays, and ceramics.

In some embodiments, composites comprise a polymer and the coated glass bubbles dispersed therein. The polymer may be a thermoplastic, a thermoset polymer or an elastomeric polymer, and the composite may contain a mixture of polymers. Suitable polymers for the composite may be selected by those skilled in the art, depending at least partially on the desired application.

In some embodiments, the polymer in the composite disclosed herein is a thermoplastic. Exemplary thermoplastics include polyolefins, fluorinated polyolefins, polyimide, polyamide-imide, polyether-imide, polyetherketone resins, polystyrenes, polystyrene copolymers, polyacrylates, polymethacrylates, polyesters, polyvinylchloride (PVC), liquid crystal polymers (LCP), polyphenylene sulfides (PPS), polysulfones, polyacetals, polycarbonates, polyphenylene oxides (PPO), polyphenyl ether (PPE), and blends thereof.

In some embodiments, the polymer in the composite disclosed herein is a thermoset polymer. Exemplary thermoset polymers include epoxies, polyesters, polyurethanes, polyureas, silicones, polysulfides, phenolics, vulcanized rubber, Bakelite™ (polyoxybenzylmethylenglycolanhydride), vinyl ester resin, and blends thereof.

In some embodiments, the polymer in the composite disclosed herein is elastomeric. Exemplary useful elastomeric polymers include polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), poly(butadiene-co-pentadiene), chlorosulfonated polyethylenes, polysulfide elastomers, silicone elastomers, poly(butadiene-co-nitrile), hydrogenated nitrile-butadiene copolymers, acrylic elastomers, ethylene-acrylate copolymers, fluorinated elastomers, fluorochlorinated elastomers, fluorobrominated elastomers and combinations thereof. The elastomeric polymer may be a thermoplastic elastomer. Exemplary useful thermoplastic elastomeric polymer resins include block copolymers, made up of blocks of glassy or crystalline blocks of, for example, polystyrene, poly(vinyltoluene), poly(t-butylstyrene), and polyester, and elastomeric blocks of, for example, polybutadiene, polyisoprene, ethylene-propylene copolymers, ethylene-butylene copolymers, polyether ester, and combinations thereof. Some thermoplastic elastomers are commercially available, for example, poly(styrene-butadiene-styrene) block copolymers marketed by Shell Chemical Company, Houston, Texas, under the trade designation “KRATON”.

In some embodiments, the polymer in the composite is silicone.

Other additives may be incorporated into the composite according to the present disclosure depending on the application, e.g., preservatives, curatives, mixing agents, colorants, dispersants, floating or anti-setting agents, flow or processing agents, wetting agents, air separation promoters, functional nanoparticles, acid/base or water scavengers, or combinations thereof.

In some embodiments, the composites according to the present disclosure comprise an impact modifier (e.g., an elastomeric resin or elastomeric filler). Exemplary impact modifiers include polybutadiene, butadiene copolymers, polybutene, ground rubber, block copolymers, ethylene terpolymers, core-shell particles, and functionalized elastomers available, for example, from Dow Chemical Company, Midland, MI, under the trade designation “AMPLIFY GR-216”.

In some embodiments, composites disclosed herein may comprise other density modifying additives like plastic bubbles (e.g., those available under the trade designation “EXPANCEL” from Akzo Nobel, Amsterdam, The Netherlands), blowing agents, or heavy fillers. In some embodiments, composites disclosed herein may further comprise at least one of glass fiber, wollastonite, talc, calcium carbonate, titanium dioxide (including nano-titanium dioxide), carbon black, wood flour, other natural fillers and fibers (e.g., walnut shells, hemp, and corn silks), silica (including nano-silica), and clay (including nano-clay).

In some embodiments, the coated glass bubbles of the present disclosure have a d₅₀ particle diameter less than 200 micrometers (μm), less than 150 μm, less than 100 μm, or even less than 50 μm. In some embodiments, the coated glass bubbles have a d₅₀ particle diameter ranging from 1 μm to 200 μm, 10 μm to 100 μm, 10 μm to 75 μm, or even 10 μm to 40 μm. The coated glass bubbles with a d₅₀ particle diameter less than 200 microns have utility for many applications, some of which require certain size, shape, density, and/or strength characteristics. For example, glass bubbles are widely used in industry as additives to polymeric compounds where they may serve as modifiers, enhancers, rigidifiers, and/or fillers. Generally, it is desirable that the coated glass bubbles be strong enough to avoid being crushed or broken during further processing of the polymeric composite, such as by high pressure spraying, kneading, extrusion or injection molding. For many applications, it is also desirable to provide low density coated glass bubbles, for example, in applications wherein weight is an important factor.

In some embodiments, the composite may comprise up to 60, 55, 50, 45, 40, 35, 30 percent by volume of the coated glass bubbles, based on the total volume of the composite. In some embodiments, the composite material may comprise from 10 to 60, from 20 to 50, or from 30 to 50 percent by volume of the coated glass bubbles, based on the total volume of the composite.

In some embodiments, the composite may comprise up to 40, 35, 30, 25, 20 wt. % of the coated glass bubbles, based on the total weight of the composite. In some embodiments, the composite material may comprise from 5 to 40, from 10 to 40, or from 15 to 35, wt. % of the coated glass bubbles, based on the total weight of the composite.

The dielectric properties of the composite material, i.e., of a composition comprising a polymer matrix material and coated glass bubbles dispersed in the matrix material, may be improved compared to the dielectric properties of the unfilled polymer, i.e., dielectric constant and dielectric loss factor, of the composite material may be lower than for the unfilled polymer.

### Articles

The coated glass bubbles of the present disclosure may be used in any variety of applications where glass bubbles are currently used. However, the coating described herein can advantageously reduce the dielectric loss and/or reduce the alkali leaching of soda-lime borosilicate glass bubbles, making the coated glass bubbles of the present disclosure particularly suited for use in articles such as printed circuit boards and telecommunications devices. In some particularly advantageous embodiments, the coated glass bubbles are used as filler for polymer-based composites used to make printed circuit boards in the electronics industry.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

TABLE 1
Materials used in the Examples

| Abbreviation | Description and Source |
|---|---|
| h-BN | Boron nitride powder of highly crystalline single |
| | platelets, available under the trade designation |
| | 3M BORON NITRIDE COOLING FILLER |
| | PLATELETS CFP 007HS from 3M Company, |
| | St. Paul, MN |
| Graphene Oxide | Single layer platelets available from Graphene |
| | Labs Inc., New York City, NY |
| Glass Bubbles A | Hollow glass microspheres, available under the |
| | trade designation 3M GLASS BUBBLES IM16K |
| | from 3M Company, St. Paul, MN |
| SYLGARD | Two-part silicone elastomer kit available under |
| Silicone | the trade designation SYLGARD 184 from Dow |
| | Corning, Midland, MI |

### Test Methods

### Moisture Sensitivity Test Method

Glass bubbles, coated and uncoated, were analyzed using a 851 TITRANDO KF COULOMETER with an 874 OVEN SAMPLE PROCESSOR, both available from Metrohm AG, Herisau, Switzerland. About 0.2 gram of glass bubbles was weighed into a vial and the vial sealed. The oven temperature was set at 250 °C. Two tests were conducted per sample and the results averaged. The average results are provided in Table 3.

### Electromagnetic (EM) Characterization Test Method

Complex dielectric and magnetic properties (i.e., permittivity and permeability properties) were calculated from Scattering(S) parameters obtained with an Agilent E8363C PNA Microwave Network Analyzer, available from Agilent, Santa Clara, CA, at 5.6 GHz using a split post dielectric resonator cavity method following ASTM D150 and IEC 61189-2-721 standards. The scattering parameters of the test samples that correspond to the reflection (Si 1 and S22) and transmission (S21 and S12) of an EM wave were measured using the microwave vector network analyzer described above. The real and the imaginary components of the complex dielectric permittivity and magnetic permeability were determined from the complex scattering parameters using the well-known Baker-Jarvis model.

Intrinsic dielectric properties of the glass bubbles were extracted from the composite dielectric data using the Effective Medium Theory (EMT) model involving a Layered Bruggemen (LBG) model as described in the following references: Dielectric mixture model for a hollow-ceramic-sphere composite, Journal of Applied Physics 77, 6456, 1995; Embedded nonlinear passive components on flexible substrates for microelectronics applications, Journal of Materials Science: Materials in Electronics 28 (15), 11550-11556, 2017; and Improved thermal conductivity and AC dielectric breakdown strength of silicone rubber/h-BN composites, Composites Part C: Open Access 2, 100023.

### Examples 1~4 (EX-1 Through EX-4)

Glass Bubbles A and h-BN were mixed together in a glass jar using a ball milling roller at 30 revolutions per minute (rpm) according to the stoichiometric ratios and times set forth in Table 2. Moisture sensitivity for the coated glass bubbles is reported in Table 3.

### Comparative Example 1 (CE-1)

Glass Bubbles A were used as received. Moisture sensitivity for the glass bubbles is reported in Table 3.

TABLE 2
Stoichiometric Amounts of Starting Material
and Ball Milling Roller Times

| | | | Wt. % of h-BN | |
|---|---|---|---|---|
| | Glass Bubble | h-BN | on Coated | Ball Milling Roller |
| Example | A (g) | (g) | Glass Bubble | Time (hours) |
| EX-1 | 2 | 0.1 | 4.76 | 12 |
| EX-2 | 3 | 0.1 | 3.22 | 12 |
| EX-3 | 2 | 0.1 | 4.76 | 24 |
| EX-4 | 3 | 0.1 | 3.22 | 24 |

TABLE 3
Moisture Sensitivity

| | Moisture |
|---|---|
| | Sensitivity |
| Example | (ppm water) |
| CE-1 | 3147 ± 34 |
| EX-1 | 2757 ± 6 |
| EX-2 | 2774 ± 27 |
| EX-3 | 2596 ± 23 |
| EX-4 | 2649 ± 13 |

ppm = parts per million

### Comparative Examples 2-4 (CE-2 Through CE-4) and Examples 6-10 (EX-6 Through EX-10)

Composites were made as indicated in Table 4 using glass bubbles from CE-1 (Glass Bubbles A), EX-1 and EX-2 as fillers. In a plastic cup, the required amount of SYLGARD Silicone Part A was degassed under vacuum for 10-15 minutes. The required amount of SYLGARD Silicone Part B was then added to the degassed Part A. To this mixture was added 30, 40 or 50 vol. % filler. The plastic cup was covered with a cap configured to allow speed mixing under vacuum (100 millibar) for 2 minutes and 15 seconds. The mixture was then poured onto a stainless-steel plate. A second stainless steel plate was placed on top of the mixture. Teflon sheets were place between the mixture and each of the steel plates to make smooth surface composites. Appropriate spacers were used between the two plates to separate them to a desired thickness (0.3 mm, 0.7 mm and 1.0 mm). The plates containing the mixture were hot pressed at a temperature of 118 °C under a pressure of 3 tons for 45-60 minutes. The plates were allowed to cool for 30-45 minutes before the cured composite sheet was removed. A sample with no fillers was also prepared to calculate and utilize the dielectric properties of the host polymer samples (in this case, silicone) for the EMT models, as described above.

Complex dielectric and magnetic properties were obtained using the Effective Medium Theory model, as described above in the Electromagnetic Characterization Test Method. Results are reported in Table 4.

TABLE 4
Uncoated and h-BN coated Glass Bubble (GB) Composites

| | | Vol. % and | GB:h-BN | Wt. % of h-BN | | | |
|---|---|---|---|---|---|---|---|
| | | Wt. % of | Weight | on Coated Glass | ε′ of | ε″ of | tanδ of |
| Example | Filler | Filler | Ratio | Bubble | filler | filler | filler |
| CE-2 | CE-1 | 30/16 | n/a | n/a | 1.85 | 0.0125 | 0.0067 |
| CE-3 | CE-1 | 40/23 | n/a | n/a | 1.82 | 0.0123 | 0.0068 |
| CE-4 | CE-1 | 50/31 | n/a | n/a | 1.77 | 0.0125 | 0.0070 |
| EX-5 | EX-1 | 30/16 | 20:1 | 4.76 | 1.72 | 0.010 | 0.0058 |
| EX-6 | EX-2 | 30/16 | 30:1 | 3.22 | 1.73 | 0.010 | 0.0057 |
| EX-7 | EX-1 | 40/23 | 20:1 | 4.76 | 1.71 | 0.010 | 0.0057 |
| EX-8 | EX-2 | 40/23 | 30:1 | 3.22 | 1.70 | 0.010 | 0.0058 |
| EX-9 | EX-1 | 50/31 | 20:1 | 4.76 | 1.75 | 0.010 | 0.0055 |
| EX-10 | EX-2 | 50/31 | 30:1 | 3.22 | 1.75 | 0.010 | 0.0058 |

n/a = not applicable.

### Examples 11-14 (EX-11 Through EX-14)

Glass Bubbles A and graphene oxide (GO) were mixed together in a glass jar using a ball milling roller at 30 rpm according to the stoichiometric ratios and times set forth in Table 5.

TABLE 5
Stoichiometric Amounts of Starting Material
and Ball Milling Roller Times

| | | | Wt. % of GO | |
|---|---|---|---|---|
| | Glass Bubbles | GO | on Coated | Ball Milling Roller |
| Example | A (g) | (g) | Glass Bubble | Time (hours) |
| EX-11 | 2 | 0.1 | 4.76 | 12 |
| EX-12 | 3 | 0.1 | 3.22 | 12 |
| EX-13 | 2 | 0.1 | 4.76 | 24 |
| EX-14 | 3 | 0.1 | 3.22 | 24 |

### Comparative Examples 5-7 (CE-5 Through CE-7) and Examples 15-20 (EX-15 Through EX-20)

Composites were made as indicated in Table 6 using glass bubbles from CE-1 (Glass Bubbles A), EX-11 and EX-12 as fillers. In a plastic cup, the required amount of SYLGARD Silicone Part A was degassed under vacuum for 10-15 minutes. The required amount of SYLGARD Silicone Part B was then added to the degassed Part A. To this mixture was added 30, 40 or 50 vol. % filler. The plastic cup was covered with a cap configured to allow speed mixing under vacuum (100 mbar) for 2 minutes and 15 seconds. The mixture was then poured onto a stainless-steel plate. A second stainless steel plate was placed on top of the mixture. Teflon sheet were placed between the mixture and each of the steel plates to make the smooth surface composites. Appropriate spacers were used between the two plates to separate them to a desired thickness (0.3 mm, 0.7 mm and 1.0 mm). The plates containing the mixture were hot pressed at a temperature of 118 °C under a pressure of 3 tons for 45-60 minutes. The plates were allowed to cool for 30-45 minutes before the cured composite sheet was removed. A sample with no fillers was also prepared to calculate and utilize the dielectric properties of the host polymer samples (in this case, silicone) for the EMT models, as described above.

Complex dielectric and magnetic properties were obtained using the Effective Medium Theory model, as described above in the Electromagnetic Characterization Test Method. Results are reported in Table 6.

TABLE 6
Uncoated and GO Coated Glass Bubble (GB) Composites

| | | Vol. % and | GB:GO | Wt. % of GO | | | |
|---|---|---|---|---|---|---|---|
| | | Wt. % of | Weight | on Coated | ε′ of | ε″ of | tanδ of |
| Example | Filler | Filler | Ratio | Glass Bubble | filler | filler | filler |
| CE-5 | CE-1 | 30/16 | n/a | n/a | 1.85 | 0.0125 | 0.0067 |
| CE-6 | CE-1 | 40/23 | n/a | n/a | 1.82 | 0.0123 | 0.0068 |
| CE-7 | CE-1 | 50/31 | n/a | n/a | 1.77 | 0.0125 | 0.0070 |
| EX-15 | EX-11 | 30/16 | 20:1 | 4.76 | 1.82 | 0.0117 | 0.0064 |
| EX-16 | EX-12 | 30/16 | 30:1 | 3.22 | 1.82 | 0.0115 | 0.0063 |
| EX-17 | EX-11 | 40/23 | 20:1 | 4.76 | 1.80 | 0.0122 | 0.0066 |
| EX-18 | EX-12 | 40/23 | 30:1 | 3.22 | 1.78 | 0.0110 | 0.0061 |
| EX-19 | EX-11 | 50/31 | 20:1 | 4.76 | 1.74 | 0.0118 | 0.0067 |
| EX-20 | EX-12 | 50/31 | 30:1 | 3.22 | 1.76 | 0.0115 | 0.0065 |

n/a = not applicable.

Thus, the present disclosure provides, among other things, coated glass bubbles, methods for making coated glass bubbles, composites comprising the coated glass bubbles, and articles comprising the composites. Various features and advantages of the present disclosure are set forth in the following claims.

1. Coated glass bubbles comprising:
glass bubbles, each glass bubble having an outer surface; and
a coating comprising flakes in direct contact with the outer surface,
wherein the flakes comprise less than 5 wt. % of the coated glass bubbles, and
wherein the coating has a thickness ranging from 2 nanometers to 5 micrometers.

2. The coated glass bubbles of claim 1, wherein the flakes comprise hexagonal boron nitride (h-BN), graphene oxide (GO), graphitic carbon nitride, or combinations thereof.

3. The coated glass bubbles of claim 1, wherein the flakes comprise hexagonal boron nitride (h-BN), graphene oxide (GO), or combinations thereof.

4. The coated glass bubbles of claim 1, wherein the flakes comprise hexagonal boron nitride (h-BN).

5. (canceled)

6. The coated glass bubbles of claim 1, wherein the coating covers at least 50% of the outer surface of the glass bubble.

7. (canceled)

8. The coated glass bubbles of claim 1, where the coating does not comprise a binder.

9. The coated glass bubbles of claim 1, wherein the glass bubbles comprise a soda-lime borosilicate glass.

10. The coated glass bubbles of claim 9, wherein the glass bubbles comprise:
50 to 90 wt. % silica;
2 to 20 wt. % alkali metal oxide; and
1 to 30 wt. % boron oxide
based on the total weight of the glass bubble.

11. The coated glass bubbles of claim 1, wherein the glass bubbles have a median size by volume ranging from 1 micrometer to 500 micrometers.

12. A composite comprising:
a polymer; and
the coated glass bubbles of claim 1 dispersed within the polymer.

13. The composite of claim 12, wherein the composite comprises 10 to 60 vol. % of coated glass bubbles.

14. The composite of claim 12, wherein the polymer is thermoplastic and selected from the group consisting of polyolefins, fluorinated polyolefins, polyimide, polyamide-imide, polyether-imide, polyetherketone resins, polystyrenes, polystyrene copolymers, polyacrylates, polymethacrylates, polyesters, polyvinylchloride (PVC), liquid crystal polymers (LCP), polyphenylene sulfides (PPS), polysulfones, polyacetals, polycarbonates, polyphenylene oxides (PPO), polyphenyl ether (PPE), and blends thereof.

15. The composite of claim 12, wherein the polymer is a thermoset selected from the group consisting of epoxies, polyesters, polyurethanes, polyureas, silicones, polysulfides, phenolics, vulcanized rubber, polyoxybenzylmethylenglycolanhydride, vinyl ester resin, and blends thereof.

16. The composite of claim 12, wherein the composite further comprises preservatives, curatives, mixing agents, colorants, dispersants, floating or anti-setting agents, flow or processing agents, wetting agents, air separation promoters, functional nanoparticles, acid/base or water scavengers, or combinations thereof.

17. The composite of claim 12, wherein the coated glass bubbles have a d₅₀ particle diameter ranging from 1 micrometers to 200 micrometers.

18. An article comprising the composite of claim 12.

19. The article of claim 18 comprising a printed circuit board.

20. A method of making the coated glass bubbles of claim 1 comprising:
combining the glass bubbles with a layered precursor;
mechanically exfoliating the layered precursor to create flakes; and
coating the glass bubbles with the flakes.

21-22. (canceled)

23. The method of claim 20, wherein the method is carried out at room temperature.

24. The method of claim 20, wherein the method is substantially free of liquids.

25. (canceled)
